(19) United States
(12) Patent Application Publication
(10) Pub. No.: US 2003/0196546 A1
(43) Pub. Date: Oct. 23, 2003

(54) Piston apparatus composed of metal piston ring without kerf

(76) Inventor: Mituhiro Kanao, Kure-Shi (JP)

Correspondence Address: LAW OFFICE OF BARRY R LIPSITZ, 755 MAIN STREET, MONROE, CT, 06468, US

(21) Appl. No.: 10/184,272

(22) Filed: Jun. 27, 2002

(30) Foreign Application Priority Data
Apr. 22, 2002 (JP) 2002-158321

(51) Int. Cl. F16J 1/04

(52) U.S. Cl. 92/214

(57) ABSTRACT

The object is to obtain a piston apparatus having a metal cylindrical piston ring without kerf that causes substantially no gas leak.

Composition of a piston apparatus wherein a slap prevention dish spring ring and a metal cylindrical piston ring without kerf are inserted in a piston body equipped with a collar stage and thereafter fixed by a snap ring for rear shaft.

### BACKGROUND OF THE INVENTION

1. Field of the Invention

The present invention concerns a piston apparatus.

2. Detailed Description of the Prior Art

All steel pistons rings disposed on the conventional piston apparatus are annular piston rings provided with kerf (split) and a piston apparatus using a metal cylindrical piston ring without kerf is unprecedented.

Cast iron solid piston was used at the time when the internal-combustion engine was invented. A piston apparatus equipped with a thin and light piston ring becomes necessary along with the increase of demands of internal-combustion engine in place of a heavy solid piston generating considerable vibration and noise. However, the use of piston rings provided with a kerf begins, because the piston ring can be inserted into the piston ring only when one end thereof is cut off. The disposition of kerf allows expansion by spring effect of the piston itself or gas pressure and is also appropriate for friction and wear and, gas leak from one stage can be reduced by the labyrinth effect in case of multi-stage, promoting an active use for the moment. Consequently, it is not yet devised to use a metal cylindrical piston ring without kerf. The difference of coefficient of thermal expansion between the piston body made of light alloy and the cylinder made of cast iron is significant, therefore, seizing will occur if a backlash is not created by increasing the gap between the cylinder wall face and the piston body wall face. Nevertheless, the creation of backlash provokes piston side knocking, piston slant sliding accompanying gas leak or others, namely a so-called slap action; and a piston ring become like an edged tool under the conditions of thin width (2.5 mm, 4 mm for oil ring), quenching, high hardness high chromium plating without R plane or chamfering of 30° to 45° exerts effects of scraper cutting (scraping or scrapper processing) along an angle of about 1 degrees to the cylinder wall face when the starting. Moreover, bad conditions such as sliding with deformation friction with an significant gas leak from the outer circumference of the piston ring including a kerf portion presenting a weak spring force or others are exerted especially during the starting where the thermal expansion is low and, therefore, gas leak due to the scraping action does not stop even when a sufficient supplying lubrication is performed during the operation. As such piston ring having an astonishing problem is used for the internal-combustion engine, in the gasoline engine, unburned hydrocarbon or carbon dioxide are discharged in quantity and in the case of diesel engine, the cylinder wall face is removed by the thin width piston ring to which a high pressure attaining 20 to 60 atmospheric pressures is applied, reducing the pressure and at the same time causing various problems of exhaust, smoke exhaust, soot or others.

The practical rotation speed of an internal-combustion engine is 1000 to 4000 rpm and in the case of refrigeration pump, 1000 to 1500 rpm for electric motor direct coupled type. Under this condition, lubricant in the crankcase bottom supplies lubrication sufficiently the cylinder wall face and the piston by means of a splash supplying lubrication board at the lower end of the connecting rod. Howsoever, it is difficult to stop the scraping action for a narrow width piston ring presenting little plane for affording the round. Besides, the explosion power applied to the inside face of the compression ring attains 20 to 30 atmospheric pressures in the gasoline engine, and 40 to 50 atmospheric pressures in the case of diesel engine, a mean effective pressure of 10 to 15 atmospheric pressures is applied for the gasoline engine and a mean effective pressure of 20 to 25 atmospheric pressures is applied for the diesel engine, and is enlarged by the spring tensile force of the piston ring itself and the gas pressure, exerts a sliding effect with an important friction resistance, and the intersection port opens under pressure to let gas pass through, increasing useless fuel consumption. The conventional C-shape oil ring is not a ring for supplying lubrication as it is called oil dipper ring. It concerns an oil ring for scraping excessive oil. However, being provided with oil groove and many oil holes, oil rings are used in accordance with the custom without clearly knowing the object of supplying lubrication, scraping, or cooling. In addition, both the piston ring having a kerf and the piston body do not fix the central point, therefore both the piston ring having a kerf and the piston body deviation and one-side hitting.

On the other hand, the piston ring having a kerf is also used for a piston type pump for freezing requiring a high vacuum action, but since the piston ring shrinks by the vacuum action, the vacuum action by the piston is hardly obtained. Only a weak vacuum action is obtained by a high speed rotation of a piston body made of light metal presenting a large capacity. Piston rings without kerf made of leather or synthetic resin having extensibility are used for a small coolant pump, but it does not concern a metal piston ring without kerf that does not expand according to the present invention.

insert supplement

The present invention intends to solve the exhaust pollution problem caused by gas leak from the piston apparatus equipped with a metal piston ring with kerf.

### SUMMARY OF THE INVENTION

As shown in FIG. 1, in a piston apparatus using a metal cylindrical piston ring 5 without kerf having a round face, a dish spring ring 3 with kerf considering the air-tightness for preventing thermal expansion and slapping is disposed between the piston body 1 and the cylindrical piston ring 5. A collar sate 2 is disposed on the lower part of the piston body 1, in the piston body 1, first a slap prevention dish spring ring 3 is inserted in a ring groove 4 and following this a metal cylindrical piston ring 5 without kerf is inserted and thereafter a snap ring 6 for shaft having a V-shape or a hole for snap ring pliers is inserted into a snap ring groove 7 for shaft. The corner of the metal cylindrical piston ring 5 without kerf is chamfered in a way to afford a round plane of the order of 0.2 to 0.5 mm as shown in FIG. 1. A dedicated special steel is used for dish spring ring 3, cylindrical piston ring 5 and snap ring 6 for shaft, and the heat treatment such as nitriding, cemented and quenching or other heat treatment is required.

As shown in FIG. 4, in a skirt part 11 of the piston, a dish spring ring 12 and a metal cylindrical piston ring 14 without kerf are inserted or press-fitted in ring grooves 13, 15 of the skirt part 11 of the piston body 10 and thereafter respective rings 12, 14 are enlarged to fix to the skirt part 11. Therefore, snap rings are not used. The object is weigh-saving of piston apparatus, central position maintenance for preventing the cylinder wall face and the piston body side face from coming into contact, slap prevention, air-tightness, or the like. As the thermal expansion is small in the skirt part, dish spring ring may be omitted sometimes. The piston ring apparatus disposed at the piston head side uses the composition of metal cylindrical piston ring without kerf of claim 1.

As shown in FIG. 5, one point or more kerf(s) 17 is (are) provided in the skirt part 18 of the metal cylindrical piston ring apparatus without kerf to afford a collet chuck function to the skirt part 18, and the metal cylindrical piston ring without kerf 19 is press-fitted in the ring groove 20 to restore and fix.

The width of the metal cylindrical piston ring without kerf of the present invention is different according to the application, model and installation position and set as necessary.

The slap action that has been generated between the cylinder wall face and the piston apparatus outer circumference moves necessarily inside through the use of a cylindrical piston ring without kerf and the slap action occurs in a gap between the inner wall face of the cylindrical piston ring 5 and the outer circumstance of a highly heat expansible piston body 1, the slap action (saccadic action) is absorbed by the dish spring ring 3 provided in the gap. The function of the dish spring ring is to exert always a slap prevention function all over the course irrespectively of immediately after the start of a piston machine, during the operation or stop, and especially when the engine operation starts, the gap between the piston body 1 made of aluminum alloy presenting a high thermal expansion and the cylindrical piston ring 5 made of copper presenting a low thermal expansion disappears, and as they are in close contact, the slap action occurs hardly during the continuous operation.

### BRIEF DESCRIPTION OF THE DRAWINGS

FIG. 1 is a side portion of a piston apparatus having a metal cylindrical piston ring without kerf.

FIG. 2 is a front view of FIG. 1.

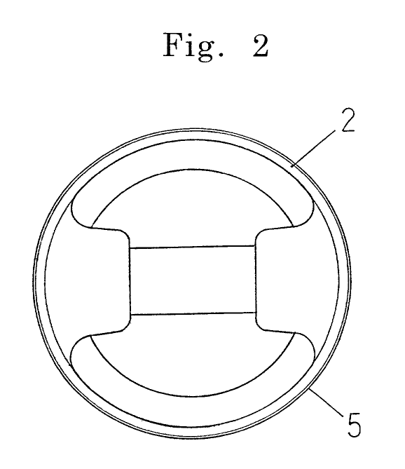

FIG. 3 is an enlarged side portion of main parts of a slap prevention dish spring ring used for the piston apparatus of the present invention.

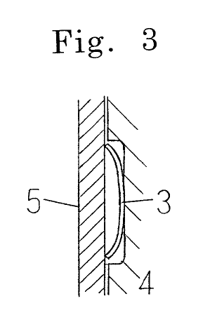

FIG. 4 is a side portion of installation of main parts of the metal cylindrical piston ring without kerf of the present invention.

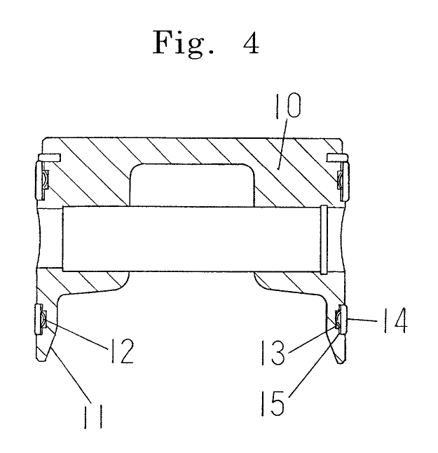

FIG. 5 is a side portion of a piston apparatus having a metal cylindrical piston ring without kerf placed at the skirt part provided with a kerf.

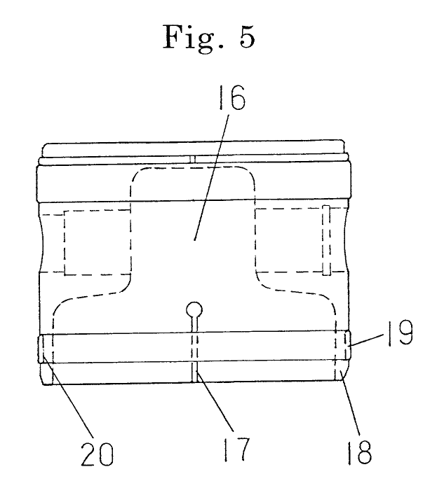

FIG. 6 is an application reference side portion of main parts of the piston apparatus, using two metal cylindrical piston rings without kerf.

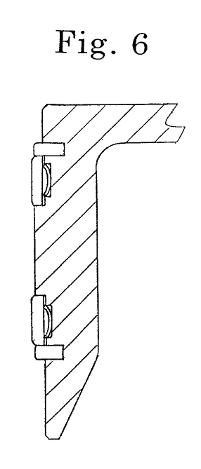

FIG. 7 is a reference view of main parts of a snap ring apparatus using a dovetail snap ring and a piston head processed by press calking.

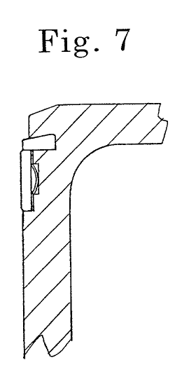

### DETAILED DESCRIPTION OF THE PREFERRED EMBODIMENTS

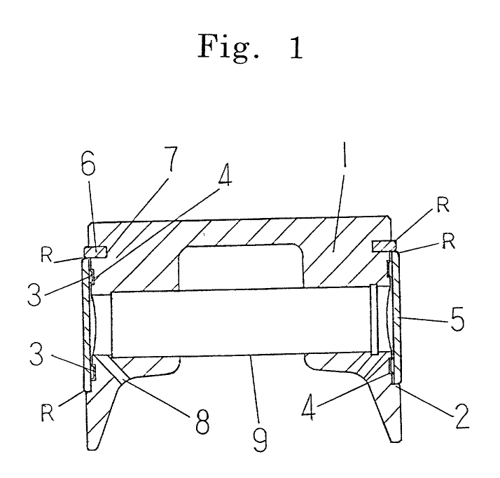

First, the application was made to a piston pump for refrigerator where experiment results can be obtained easily based on FIG. 1 and for the vacuum action of a difficult problem has been obtained outstandingly excellent performances, and a refrigeration unit of extremely low heat generation was obtained.

Specifications of experimental refrigeration unit

| | | |
|---|---|---|
| Diameter of metal cylindrical piston ring without kerf | 35 | mm |
| Width of metal cylindrical piston ring without kerf | 25 | mm |
| Thickness of metal cylindrical piston ring without kerf | 1.2 | mm |
| Stroke of piston apparatus | 20 | mm |
| Rotation speed of refrigeration unit | 1500 | rpm |
| O-ring is used for slap prevention ring | | |

Specification of experimental internal-combustion engine
Mitsubishi agricultural Ricardo type single cylinder
air-cooling gasoline engine

| | | |
|---|---|---|
| Inside diameter of cylinder | 75.15 | mm |
| Stroke of piston | 65 | mm |
| Diameter of metal cylindrical piston ring without kerf | 75.05 | mm |
| Width of metal cylindrical piston ring without kerf | 15 | mm |
| Thickness of metal cylindrical piston ring without kerf | 1.7 | mm |
| Diameter of head of conventional piston body | 74.5 | mm |
| Diameter or skirt part of conventional piston body | 74.9 | mm |

(Conditions of air-tightness test of internal-combustion engine)

The cylinder head is remove, a cover having a separately prepared O-ring is set on the upper part of the cylinder wall face, and compression pressure test and vacuum pressure test were performed in manual operation.

| | |
|---|---|
| Manually obtained maximum pressure | about 12 atmospheric pressures |
| Manually obtained maximum | 76 cm Hg |
| vacuum pressure | |

Time necessary for reducing from 76 cm Hg to about 50 cm Hg was about 20 min. Thereafter, time until a complete disappearance of vacuum pressure was about 1 hour. A slap prevention ring is not used for skirt part. A readymade piston was modified and used for the piston body.

The piston apparatus of the present invention presents a conspicuous air-tightness because it is composed of a metal cylindrical piston ring without kerf of an especially large width. Consequently, especially the soot problem of diesel engine is largely improved. Moreover, as for the piston is interposed a dish spring ring enveloped by a cylindrical piston ring without kerf, the slap action during the start is absorbed by the dish spring ring, resolving the problem of slap action of the piston. Scraping action does not occur because a round face is afforded to both end faces of the wide cylindrical piston ring. In addition, if the air-tightness is improved, it becomes possible to reduce the compression ratio (compression rate). If the compression ratio is low, the crank stroke (eccentricity rate) is also lowered, reducing the weight of the crank, the length thereof and consequently the weight of the connecting rod, and lowering vibration and noise. Since the load friction resistance due to piston ring tensile force or gas pressure disappears, the operation of a piston engine becomes smooth, reducing the fuel consumption. Since a low compression ratio is satisfactory, the discharge quantity of nitrogen oxides also becomes lower.

What is claimed is:

1. A piston apparatus, wherein a collar stage (2) is provided on a piston body (1), a slap prevention dish spring ring (3) is inserted into a ring groove (4) from a portion other than collar stage (2), next a metal cylindrical piston ring (5) without kerf is inserted and thereafter the metal cylindrical piston ring (5) without kerf where a snap ring for shaft (6) is inserted into a snap ring groove (7) is fixed to the piston body (1) with the snap ring for a rear shaft (6).

2. The piston apparatus, wherein main parts of the metal cylindrical piston ring without kerf of claim 1 is inserted into a skirt part (11) of a piston body (10) and thereafter the skirt part is enlarged to fix a dish spring ring (12) and a metal cylindrical piston ring (14) without kerf to respective ring grooves (13)(15) of the skirt part (11) of the piston body (10).

3. The piston apparatus, wherein a metal cylindrical piston ring (19) without kerf is press-fitted in a skirt part (18) provided with a kerf (17) of a piston body (16) of the piston apparatus of claim 1 to fix to a ring groove (20).
